(19) United States
(12) Patent Application Publication
(10) Pub. No.: US 2004/0261041 A1
(43) Pub. Date: Dec. 23, 2004

(54) Scalable vector graphics and monitoring diagram displays

(76) Inventors: Jayapal Dharmapalan Parakkuth, Plymouth, MN (US); Krishna Vasudevan, Crystal, MN (US)

Correspondence Address: Siemens Corporation, Intellectual Property Department, 170 Wood Avenue South, Iselin, NJ, 08830, US

(21) Appl. No.: 10/839,300

(22) Filed: May 5, 2004

Related U.S. Application Data
(60) Provisional application No. 60/475,930, filed on Jun. 4, 2003.

(51) Int. Cl. G06F 17/00; G09G 5/00; G06F 9/44

(52) U.S. Cl. 715/901; 715/513; 717/115; 715/749

(57) ABSTRACT

The present invention provides for a method and system for displaying real-time graphical representations by inserting in an XML page, SVG encoded scripts to effect a graphical representation, processing the XML page through a web page generator such that the SVG encoded scripts are processed to generate an html page containing SVG content for display on an information device; storing the html page in a memory of a server; and receiving a request for display of the html page on the display of the information device.

### CROSS-REFERENCES TO RELATED APPLICATIONS

This application claims priority to, and incorporates by reference herein in its entirety pending U.S. Provisional Application Ser. No. 60/475,930 filed on Jun. 4, 2003.

### BACKGROUND

SCADA (Supervisory Control and Data Acquisition) systems are used to monitor and control plant operations or specific equipment in a variety of industries such as telecommunications, water and waste control, energy, oil and gas refining and transportation. Functionally, SCADA systems play a variety of roles by gathering field information, such as the power output of a generator, transferring that information back to a central site, alerting a central operating site of the danger of exceeding maximum power thresholds, carrying out necessary analysis and control, such as determining anticipated loads at various nodes on a power grid and displaying the information in a logical and organized fashion. SCADA systems can be relatively simple, and may include the monitoring of environmental conditions of a various storage tanks in a petroleum processing plant or may be highly complex, and may include systems that monitor all the activity in a hydroelectric generating plant or all the activity of a water treatment plant.

SCADA systems are generally suited for the remote control of industrial processes and are available in a myriad of architectures and configurations. These systems employ the use of a multitude of control, feedback and monitoring communications channels and applications. Moreover, SCADA is a technology which is being recognized by various industries to exercise remote and distributed control of various sensors, actuators and processing equipment.

Generally, an industrial measurement and control system consists of a plurality of interrelated equipment such as controllers or Master Terminal Units (MTU), and Remote Terminal Units (RTU's) which collect field data and utilize application software for monitoring and controlling remote systems and sub-systems.

SCADA is generally used in long distance communication applications and utilizes a variety of communications medium in mostly an open-loop control structure. Alternatively, the control structure may be a combination of open-loop and closed-loop control combined with elements of short distance control, or simply a closed-loop control.

Factory and plant monitoring and control may be automatic or may be manually controlled by specific operator commands. RTUs such as programmable logic controllers are responsible for scanning and detecting the field inputs at a fast rate. Operationally, RTUs require sufficient real-time bandwidth to conduct their monitoring processes and possess sufficient processing intelligence to deal with all monitoring task. In turn, the MTU scans the entire system or a particular region of a larger system in order to detect alarm conditions and data which report system and component status.

Monitored data is generally comprised of three (3) types of feedback data. Analog outputs from networking sensing devices may be acquired at fixed intervals with the results either trended graphically or updated as numeric values. Digital data (On/Off) represents the state of switches, valves or alarm conditions. Pulse data is used to represent the value of a counter, such as for example, the revolutions and speed of rotating field equipment or machinery.

Data received by the MTU is transmitted to an operator station for display and interpretation. In accordance with the present invention, the transmitted data comprising of static and/or dynamic, and graphical data is combined in a central processor and made accessible to system operators. Real-time dynamic data is processed and received at a client monitoring site for display, and correlated with un-refreshed static and graphic data. Graphic data is encoded, and transmitted as SVG (Scalable Vector Graphics) formatted data or SVG-rendered files to a server responsible for the generation of web pages and display of system schematics at a remote client monitoring site.

### SUMMARY

According to the principles of the present invention, there is provided a method and system for displaying graphical, text and real-time dynamic data in a manner which minimizes communications bandwidth and processing capacity. The present invention discloses the use of Scalable Vector Graphic coding inserted within an XML document to generate system representations which include real-time dynamic data acquired from field sensing devices. Static, dynamic and graphic data are correlated and compiled to create html based dynamic web pages for display at a remote monitoring site.

### BRIEF DESCRIPTION OF THE DRAWINGS

A wide variety of potential embodiments will be more readily understood through the following detailed description, with reference to the accompanying drawings in which:

FIG. 1 is a diagram of an exemplary embodiment of a process and control system comprising field devices and a data processing and display system;

FIG. 2 is an illustration of an embodiment of the present invention as used in the process and control system shown in FIG. 1;

FIG. 3 is an illustration of a one-line diagram of a sub-station bus and related components; and

FIG. 4 is a composite display of SVG graphics and client-side graphics to produce a hydroelectric generating power plant schematic in accordance with the present invention.

### DETAILED DESCRIPTION

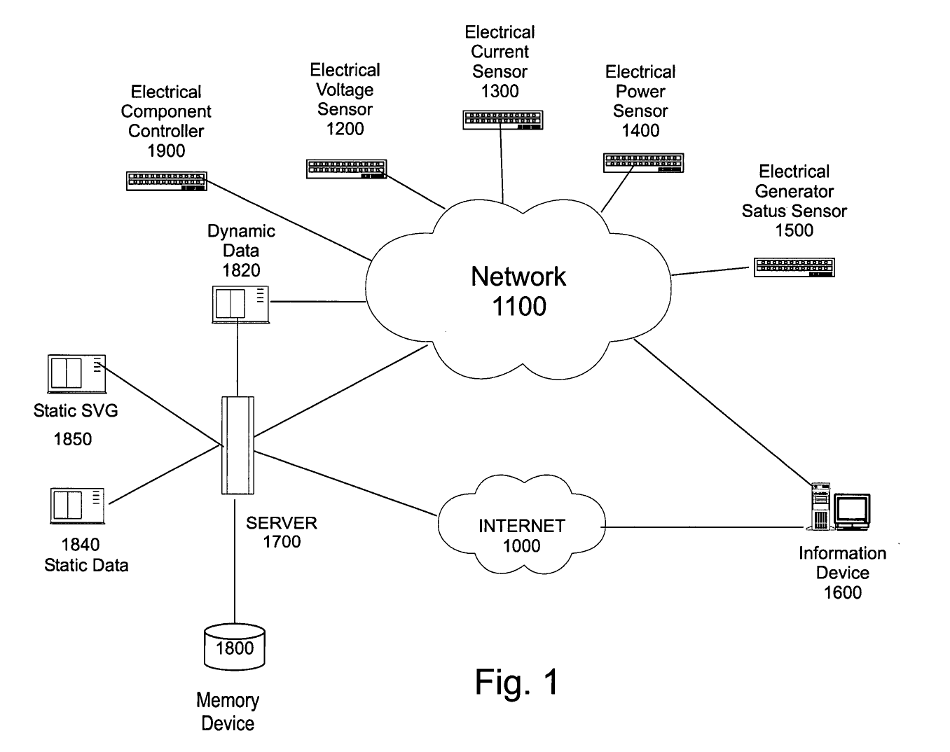

FIG. 1 is a diagram of an exemplary embodiment of a process, monitor and control system in which a network 1100 serves as the medium by which field devices such as electrical sensors and network controllers communicate. Command data to these field devices and feedback from the electrical sensors and controllers are transmitted through network 1100 to a network server 1700. Although in an embodiment of the present invention, network 1100 is referenced for illustration purposes as SCADA system, network 1100 may comprise a public, private, circuit-switched, packet-switched, virtual, radio, telephone, cellular, cable, DSL, satellite, microwave, AC power, twisted pair, Ethernet, token ring, a LAN, a WAN, the Internet, an intranet, wireless, Wi-Fi, BlueTooth, Airport, 802.11a, 802.11b, 802.11 g, etc., and/or any equivalents thereof. Network 1100 may be applied to all monitoring and control related industries including but not limited to energy management, material conveyance, material pumping, material manufacturing, electrical power generation, heating systems. Ventilation systems, air conditioning systems, chemical processing, mining, machining, packaging and/or materials distribution.

Network 1100 provides communication among electrical controller 1900, electrical voltage sensor 1200, electrical current sensor 1300, electrical power sensor 1400, electrical generator station status sensor 1500, server 1700 and client information device 1600. Network 1100 preferably operates in a bidirectional mode for transmitting command data, receiving feedback and/or monitoring data, and for allowing operator access to field performance and status data. Field sensors such as drives, actuators, circuit breakers and controllers such as voltage regulators and programmable logic controllers are monitored and/or controlled by server 1700.

In accordance with SCADA architecture, controller 1900 functions as an MTU (master terminal unit) and scans the network 1100 for any alarms or status related data from field sensors such as sensors 1200, 1300, 1400, and 1500, hereinafter referred to as “field sensors” (RTUs). For example, data sent by voltage sensor 1200 to report the sensing of an over-voltage alarm condition is detected by controller 1900. Upon detection, controller 1900 processes the alarm condition and through a predetermined set of programming instructions within controller's 1900 memory and related application software, responds with a downstream set of commands to step-down power output at the affected generation node monitored by voltage sensor 1200. Simultaneously, and preferably in real-time or near real-time, the same alarm status data and downstream commands are detected by dynamic data processor 1820. For purposes of illustration, the term processor shall mean any hardware and/or software machine and/or virtual machine comprising a set of machine-readable instructions adaptable to perform a specific task. Moreover, a processor comprises any one or combination of hardware, firmware, and/or software adaptable to perform a specific task. A processor acts upon information by manipulating, analyzing, modifying, converting, transmitting the information to an information device, and/or routing the information to an output device.

Server 1700 is a processor as referenced above and may take the form of a general purpose computer, microprocessor or any hardware and/or software based computational device capable of receiving, detecting, processing and transmitting data across network 1100. The alarm data and downstream commands are received by server 1700 from dynamic data processor 1820 and are stored in memory device 1800. Memory device 1800 is means for storing data and comprises any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory may be coupled to a processor and can store instructions adapted to be executed by the processor and in particular, capable of being accessed by server 1700. Application software operational within server 1700 and resident within memory device 1800 is used to among other functions, process received data and make available to an operator, static data 1841 and SVG data 1851 as well as dynamic data 1821 of the type representative of a changing status of a field device or condition and downstream command responses generated by the controller 1900. Dynamic data processor 1820 scans the network 1100 and captures the same alarm and/or status data detected by controller 1900 as well as downstream command data generated in response to the alarm condition. Data captured by the dynamic processor 1820 is processed and sent to server 1700 for storage in memory device 1800. Preferably the database in memory device 1800 is configured as an ODBC (Open Database Connectivity) database so as to allow access to data by any application regardless of which database management system is employed.

The captured dynamic data 1821 is used to generate a display of the status of a monitored system and its related components along with graphic data sent by SVG processor 1850 and static data 1841. For example, measured values of a display object corresponding to a power and distribution component is tagged with an identifier. Measured values for the selected power and distribution component is stored and associated with the corresponding identifier. Queries and responses referencing the identifier are then stored and made callable by designating and indexing the data with the appropriate identifier.

Alternatively, the functions of dynamic data processor 1820 may be integrated into server 1700. In that case, server 1700 may, in addition to its client-server functionalities, be responsible for scanning and capturing alarm, downstream command and other status data from field sensors and controllers and other network devices.

Other than alarm conditions, the interval by which status data sent upstream to the dynamic data processor 1820, is operator selectable. An operator, may depending on operating conditions, configure field devices such as the voltage sensor 1200 to report the status of a generator on predetermined intervals, for example, every 3 seconds. At each three (3) second intervals, the dynamic data processor 1820 will likewise process and transmit the status data to server 1700. Moreover, it should be understood that the dynamic data 1821 to be used in the monitor and control of the system should operate in real-time or in substantially real-time in order to effectuate timely monitor and control functions.

Static data processor 1840 provides static informational data which does not change unless specifically changed by a network operator. For example, static processor 1840 provides operating threshold values and set points such as maximum power output as well as general background information such as the network location or address of a field component. More specifically, static data processor 1840 also provides technological addresses or TA's which function as IDs or identifiers for entities or objects to be used to populate a display of the process and control system. For example, static data processor 1840 designates objects such as generators, circuit breakers and transformers to be used as graphic display objects on information device 1600. The object and the static and dynamic data associated with a particular object are correlated for display by server 1700 through the use of the identifier and such correlation is stored in memory device 1800.

More specifically, display objects such as generators and transformers are assigned an identifier (“ID”). The ID corresponding to a particular object has with it, a plurality of attributes which define the object in terms of its function, role, location and manipulability etc. For example an object to be represented in a display, such as a generator, may be identified as “G34” and may have associated with it, the attributes of function, backup role, display location and required security level for access to monitoring and control functions. An illustration of a segment or portion of the data stored data is shown below.

[image]

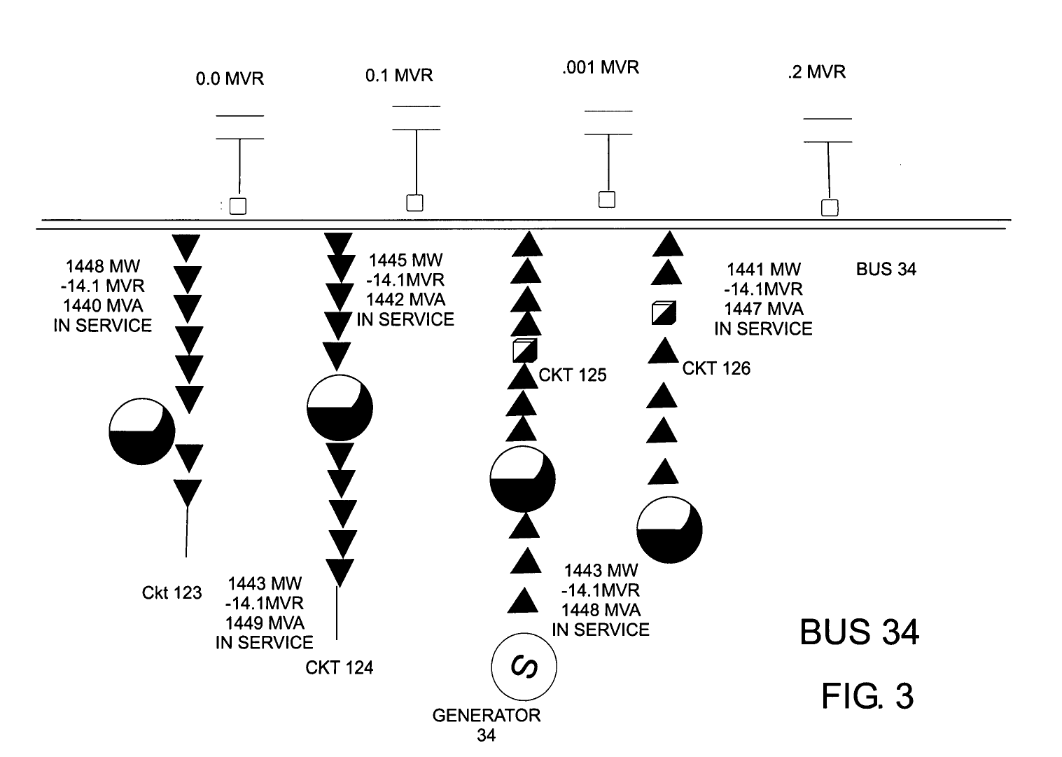

In the data shown above, the object identified as “G34” is designated as a generator functioning as a backup power source. The generator is designated as an object displayable on a display 14 or 27. The display 14 or 27 is a selectable display of a system or component diagram. The generator is located on bus 34, third ckt line and in the 13^{th} position. (See FIG. 3). Within the database in memory device 1800, the static data is preferably stored and correlated with dynamic data values such as the real power measurement of 1443 MW. Additionally, the object G34 may have other data associated with it for creating the displays 14 Or 27 referenced above—such as text displays (Banners etc.) and other dynamic data associated with the display of the generator object G34. All data is preferably correlated, stored and retrieved using the identifier “G34”.

SVG processor 1850 is the source for graphical display of a monitored system and its associated components. Initially, display objects and other associated graphics may be generated, for example, through CAD systems. However, depending on the format compatibility between formats used on display editors in the CAD system to create the graphic displays, a conversion to an SVG format may be required. Conversion is accomplished through the use of conversion software tools on SVG processor 1850. Graphic files from a CAD graphics editor in a non-SVG format are converted to SVG files for input to server 1700. The static graphical representation of a power and distribution system, for example, is sent to server 1700 as an SVG rendered file. Should the need arise to display other system displays, SVG files representative of that other system display are sent to and accessed by server 1700 for storage, processing and transmission to a client. Alternatively, all graphic data relating to all displays may be stored in memory device 1800 and rendered accessible upon command. If memory space considerations are an issue, server 1700 may request a retransmission of each graphical display at the time it is needed. Otherwise, static graphic representations may be sent as SVG rendered files pre-stored in memory device 1800 and made accessible upon demand. Preferably, the SVG graphic representations are sent via an SVG rendered file for inclusion into an XML page or document as an embedded or inserted set of SVG instructions viewable by a web browser having an SVG plug-in. For purposes of clarity, it should be understood that reference to the term SVG-rendered means made perceptible via SVG.

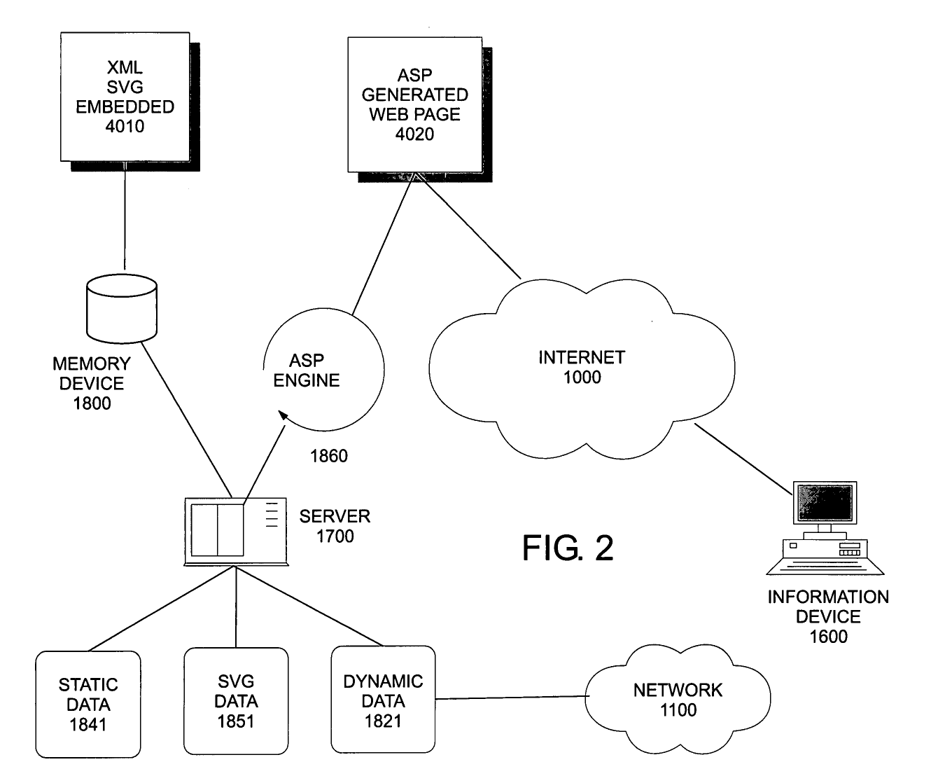

In accordance with an embodiment of the present invention, requests for status updates are made through information device 1600. As shown in FIG. 2, an operator functioning as a client requests a particular display by sending server 1700 an http request through a browser such as Microsoft Explorer or Netscape. The browser includes an SVG plug-in in order to display a graphic representation of a designated display of a system, subsystem or component. SVG data 1851, static data 1841, and dynamic data 1821 are forwarded to server 1700 where static and dynamic data 1841, 1821 are stored in a predefined data structure which preferably expedites the access and web page generation process. The stored SVG data 1851, static data 1841, and dynamic data 1821 are used to create an XML document 4010 having both XML and SVG scripts. Preferably, prior to receiving a display command from information device 1600, SVG scripts embedded within XML document 4010 are executed by ASP engine 1860 to generate graphic content which is storeable in memory device 1800 and which is displayable on information device 1600. The resulting ASP web page 4020 contains SVG content as well as server-side and client-side unexecuted code in html format. The generated html page 4020 is then forwarded back to the browser as an http stream for display on information device 1600. The generated html page 4020 is received and executed by the browser in order to display a power generation schematic or diagram referenced above and as shown in FIG. 2. It should be understood that the creation of the requested display may not only be dependent on the instruction set in SVG and XML code and associated server-side scripts, but may dependent on client-side scripts and/or application software resident on information device 1600. Client-side libraries and object sets may also be used to complement the display of the generated web page 4020. Moreover, it is preferable that graphical displays on an XML page containing SVG scripts are pre-executed and stored within the resulting html page as SVG content and other client and server side scripts and data content.

Once static and graphic content are displayed on information device 1600, only dynamic data 1821 is repeatedly refreshed in real-time or near real-time. The static and graphic data content are preferably not refreshed. Dynamic data 1821 refreshing may be a functional part or assigned task of the server 1700 or client (information device 1600). Whether the client 1600 or server 1700 is responsible for the repeated request and/or processing of dynamic data 1821 may be determined by server-side and/or client-side scripts associated with a particular display. For example, server-side requests and processing of dynamic data 1821 may be part of server-side scripts on the html page executed at the time that the html page(s) is sent to the web browser. By operating in this manner, bandwidth is conserved and processing capacity at both server 1700 and information device 1600 are minimized.

Alternatively, the XML document 4010 may be processed in a more complete manner to expedite performance. For example, in the above referenced step in which the XML document 4010 is processed to produce an html document, only the SVG code was executed. However, unexecuted server-side code in the XML document 4010 may likewise be ASP executed. Only client-side scripts and dynamic data refresh scripts may remain.

In another embodiment of the invention, the XML document 4010 may be ASP executed only at the time that a display request is received. (i.e., at every operator selection of a particular display).

Shown in FIG. 3, is exemplary display (14) requested by the client. The display is a “one-line diagram” of bus 34 and illustrates a portion of the structure of a power and distribution system. The one-line diagram consists of symbols such as generators, capacitors, bus segments, and power flow arrows (“objects”) as well as static text 1840 and dynamic data 1821. These objects were SVG encoded as graphic data in the XML document stored in memory device 1800. Static text data was also included and represented by headings “Generator” and “Bus 34”. Dynamic data 1821 such as values associated (i.e. identifiers) with “real power values” (MW), and reactive power (MVR) are changing and are changed in accordance with the monitoring intervals selected by the system operator, client-side and server-side scripts. Server-side scripts may command server 1700 to fetch dynamic data 1821 from controller 1900 and forward the data to the web browser. Alternatively, the browser on the client may as a result of client-side scripts, execute fetch commands to query the server 1700 to provide current (real-time data) from field controller 1900 or such functions may be shared by both the client and the server.

Alternatively, client displays may be generated by combining existing one-line diagrams with client-side generated graphics callable by server 1700. Procedurally, all the steps and alternatives discussed above may be combined with client-side generated graphics. Resident within the client information device 1600, a graphics library may be used to further create client displays. At the time that the html page is sent to the client, and embedded within the html page, commands are executed to overlay a one-line diagram over other predefined displays resident within files stored in the memory of information device 1600.

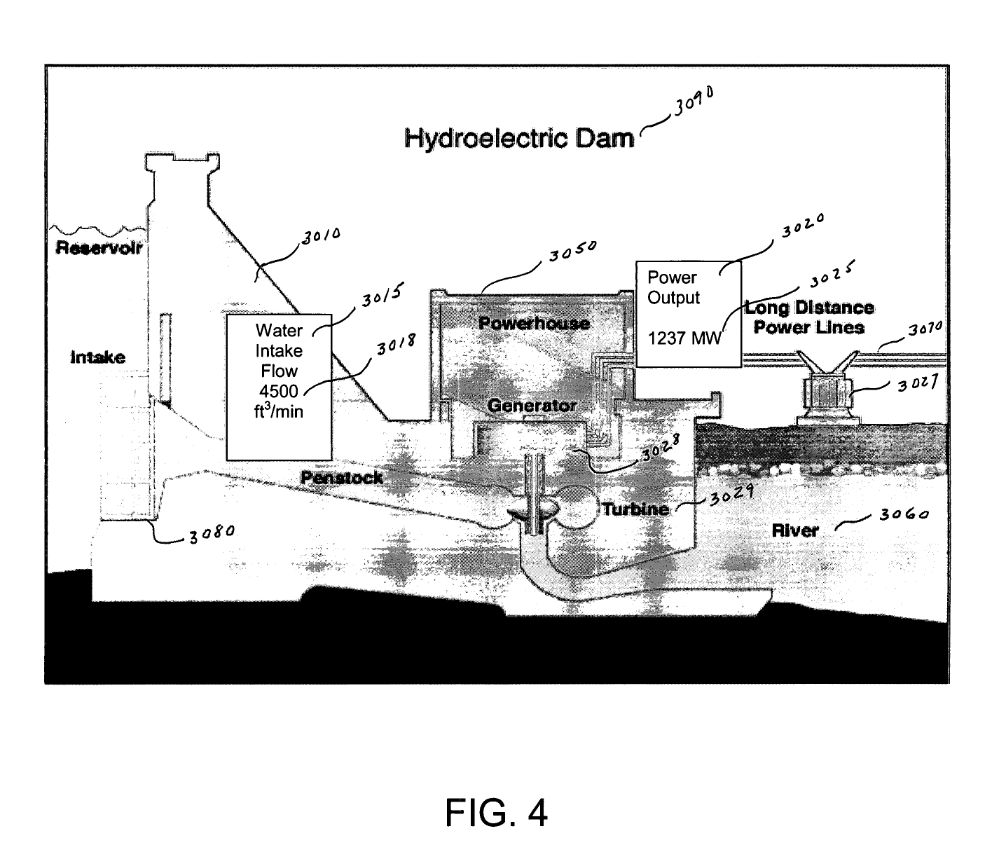

In another embodiment of the invention and as shown in FIG. 4, a display is shown of a power plant resulting from the combination of an html web page generated by server 1700 and graphic data provided by the information device 1600. An html page is generated by server 1700 in the same manner as discussed above. Objects such as the generator 3028, transformer 3027, turbine 3029 and intake gate 3080 are objects which were generated and processed by the server 1700 and in particular, processed by ASP engine 1860. These objects were initially SVG coded along with other text scripts and interactive functionalities in XML format and then ASP processed to generate an html page. Text headings such as “Water Intake Flow” 3015, “Power Output” 3020 and display title “Hydroelectric Dam” 3090 as well as the repeated display of dynamic data or measure data 1821 in real-time or near real-time, corresponding to “Water Intake Flow” 3018 and “Power Output” 1237 are scripted and executed by as discussed above by either client-side or server-side execution of retrieval and display scripts encoded initially in the XML page and then in the resultant html page. Static data and associated graphical representation of the hydroelectric power plant are constant and are preferably not refreshed. Only changing dynamic data 1821 is refreshed on a real-time basis on the display. More specifically, the monitored data represented by “Water Intake Flow” 3010 and “Power Output” 3020 headings are static data 1841 while the measurable and dynamic values of power output and water intake flow are captured by the dynamic processor 1820 and forwarded to server 1700 for real-time or nearly real-time transmission and display on information device 1600. In combination with the portion of the display provided by server 1700, information device 1600 generates and compliments the portion of the display generated by server 1700, with graphical objects and/or static data that are stored in the memory of information device 1600. Objects such as the powerhouse 3050, river 3060, and dam 3010, and associated headings such as “River” for example may be generated or accessed at the information device 1600 and combined with the objects sent via the html web page from server 1700. Utilization of client-side graphics may under certain circumstances be more efficient and therefore a preferred means of displaying graphic objects. For example, because the client-side generated objects may appear in a multitude of selectable displays, retransmission of these objects from server 1700 may be bandwidth inefficient. As such and in accordance with the present invention, client-side executed display of graphic objects, data, text, and interactive functionalities may be combined with html web pages generated and transmitted to information device 1600 and may be callable by either the server 1700 or the information device 1600. Because of the scalable nature of the graphic representation, panning, zooming and object selection, calculations, animation and sophisticated interactivity can be incorporated in the display and may be server-side or client-side initiated.

While the inventive method and system have been particularly shown and described with reference to a preferred embodiment thereof, it should be understood by those skilled in the art that various changes in form and detail may be made therein without departing from the spirit and scope of the invention.

What is claimed is:

1. A method of displaying real-time graphical representations, comprising the steps of:
inserting in an XML page, SVG encoded scripts to effect a graphical representation;
processing the XML page through a web page generator such that the SVG encoded scripts are processed to generate an html page containing SVG content for display on an information device having a display;
storing the html page in a memory of a server; and
receiving a request for display of the html page on the display of the information device.

2. The method of claim 1 further comprising the step of using a web browser to request display of the html page on the display of the information device.

3. The method of claim 1 further comprising the step of transmitting the html page to the information device.

4. The method of claim 3 further comprising the step of displaying the html page as a graphic representation on the display of the information device and wherein the displayed SVG content does not require a refresh.

5. The method of claim 4 further comprising the step of storing in the memory of the server, static data associated with the graphical representation.

6. The method of claim 5 further comprising the step of storing dynamic data acquired from a monitoring network corresponding to the graphical representation and the static data.

7. The method of claim 6 further comprising the step of transmitting the dynamic data and static data with the associated graphical representation for display on the information device.

8. The method of claim 7 further comprising the step of dynamically updating the dynamic data at predetermined intervals.

9. The method of claim 7 further comprising the step of dynamically updating the dynamic data when the dynamic data has changed.

10. The method of claim 9 wherein the dynamic data is acquired and transmitted to the information device in real-time.

11. A system of displaying real-time graphical representations, comprising:
means for embedding in an XML page, SVG encoded scripts to effect a graphical representation;
means for processing the XML page through a web page generator such that the SVG encoded scripts are processed to generate an html page containing SVG content for display on an information device having a display;
memory means on a server for storing the html page therein; and
means for receiving a request for display of the html page on the display of the information device.

12. The system of claim of 11 further comprising a web browser on the server for requesting the display of the html page on the display of the information device.

13. The system of claim 11 further comprising means for transmitting the html page to the information device.

14. The system of claim 13 further comprising means for displaying the html page as a graphic representation on the display of the information device and wherein the displayed SVG content does not require a refresh.

15. The system of claim 14 further comprising means for storing in the memory of the server, static data associated with the graphical representation.

16. The system of claim 15 further comprising means for storing in the memory of the server, dynamic data acquired from a monitoring network corresponding to the graphical representation and the static data.

17. The system of claim 16 further comprising means for transmitting the dynamic data and static data with the associated graphical representation for display on the information device.

18. The system of claim 17 further comprising means for dynamically updating the dynamic data at predetermined intervals.

19. The system of claim 17 further comprising means for dynamically updating the dynamic data when the dynamic data has changed.

20. The system claim 19 wherein the dynamic data is acquired and transmitted to the information device in real-time.

21. A computer-readable medium having stored thereon instructions which when executed by a processor, cause the processor to perform the steps of:
embedding in an XML page, SVG encoded scripts to effect a graphical representation;
processing the XML page through a web page generator such that the SVG encoded scripts are processed to generate an html page containing SVG content for display on an information device having a display;
storing the html page in a memory of a server; and
receiving a request for display of the html page on the display of the information device.
